(19) United States
(12) Patent Application Publication
(10) Pub. No.: US 2008/0297581 A1
(43) Pub. Date: Dec. 4, 2008

(54) Inkjet recording apparatus

(75) Inventors: Akira Taiji, Kyoto (JP); Arifumi Omoto, Kyoto (JP)

Correspondence Address: MCDERMOTT WILL & EMERY LLP, 600 13TH STREET, N.W., WASHINGTON, DC, 20005-3096, US

(73) Assignee: DAINIPPON SCREEN MFG. CO., LTD.

(21) Appl. No.: 12/153,929

(22) Filed: May 28, 2008

(30) Foreign Application Priority Data
Jun. 4, 2007 (JP) 2007-148147

(51) Int. Cl. B41J 2/01

(52) U.S. Cl. 347/104

(57) ABSTRACT

An inkjet recording apparatus includes color inkjet heads 11, 12, 13, 14, 15 and 16 and a white inkjet head 17 arranged in different positions with respect to a secondary scanning direction. When recording an image in a pre-white process, a recording medium S is moved in a direction of arrow A. When recording an image in a post-white process, the recording medium S is moved in a direction of arrow B. Thus, the inkjet recording apparatus is simple in construction entailing no increase in the cost of the apparatus, and yet is capable of selectively performing both the pre-white process for printing in white ink first, and then printing in color inks, and the post-white process for printing in color inks first, and then printing in white ink.

### BACKGROUND OF THE INVENTION

1. Field of the Invention

This invention relates to an inkjet recording apparatus for recording images on a recording medium by moving the recording medium in a secondary scanning direction with a recording medium transport mechanism, and moving a recording head in a primary scanning direction perpendicular to the secondary scanning direction.

2. Description of the Related Art

A known inkjet recording apparatus is described in Japanese Unexamined Patent Publication No. 2006-51773, for example. When printing images on the surface of a transparent recording medium with such an inkjet recording apparatus, for example, it is common practice to first print a background using background-color ink (e.g. white ink), allow the ink to dry, and subsequently an image using color inks such as Y, M, C and K. When printing on the back surface of the transparent recording medium in order to improve durability, printing is first done with the color inks, which are then dried, and subsequently, the background is printed on the color inks.

Thus, there are a process for printing in background-color ink first, and then printing in color inks, and a process for printing in color inks first, and then printing in background-color ink. In order to selectively execute both processes while maintaining productivity, background-color inkjet heads for discharging background-color ink must be arranged at opposite sides, in the primary scanning direction or secondary scanning direction, of a plurality of color inkjet heads arranged in the primary scanning direction for discharging the different color inks.

Where such a construction having the background-color inkjet heads arranged at opposite sides of the color inkjet heads is employed, it is necessary to install an additional background-color inkjet head. Further, this construction requires UV lamps for the white ink to be installed between the background-color ink heads and the color inkjet heads. All this causes a problem of increasing the cost of the apparatus.

### SUMMARY OF THE INVENTION

The object of this invention, therefore, is to provide an inkjet recording apparatus, simple in construction and entailing no increase in the cost of the apparatus, and yet capable of performing both the process for printing in background-color ink first, and then printing in color inks, and the process for printing in color inks first, and then printing in background-color ink, without lowering productivity.

The above object is fulfilled, according to this invention, by an inkjet recording apparatus for recording images on a recording medium by moving the recording medium in a secondary scanning direction with a recording medium transport mechanism, and moving a recording head in a primary scanning direction perpendicular to the secondary scanning direction, wherein the recording head includes a plurality of color inkjet heads arranged in an array in the primary scanning direction for discharging different color inks, and a background-color inkjet head for discharging background-color ink, the background-color inkjet head being disposed in a position different from the array of the color inkjet heads with respect to the secondary scanning direction, and adjacent one of a forward end and a rearward end of the array; and the recording medium transport mechanism is constructed to transport the recording medium selectively in a first direction in which the background-color inkjet head is located upstream with respect to the secondary scanning direction, and in a second direction in which the color inkjet heads are located upstream with respect to the secondary scanning direction.

Such an inkjet recording apparatus is simple in construction entailing no increase in the cost of the apparatus, and yet is capable of selectively performing both a process for printing in background-color ink first, and then printing in color inks, and a process for printing in color inks first, and then printing in background-color ink.

In a preferred embodiment, the inkjet recording apparatus can transport the recording medium effectively whether it is a long sheet-like material or a hard, plate-like material.

Other features and advantages of the invention will be apparent from the following detailed description of the embodiments of the invention.

### BRIEF DESCRIPTION OF THE DRAWINGS

For the purpose of illustrating the invention, there are shown in the drawings several forms which are presently preferred, it being understood, however, that the invention is not limited to the precise arrangement and instrumentalities shown.

FIG. 1 is a schematic front view of an inkjet recording apparatus according to this invention;

FIG. 2 is a perspective view of the inkjet recording apparatus according to this invention;

FIG. 3 is a perspective view of a recording head;

FIG. 4 is a plan view of the recording head;

FIG. 5 is an explanatory view schematically showing an arrangement of inkjet heads; and

FIG. 6 is an explanatory view illustrating image recording operations.

### DESCRIPTION OF THE PREFERRED EMBODIMENTS

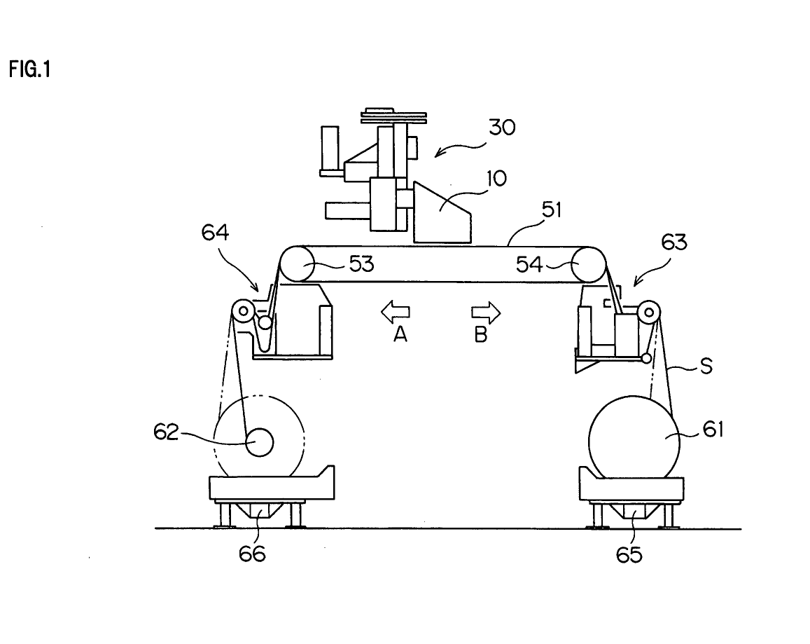

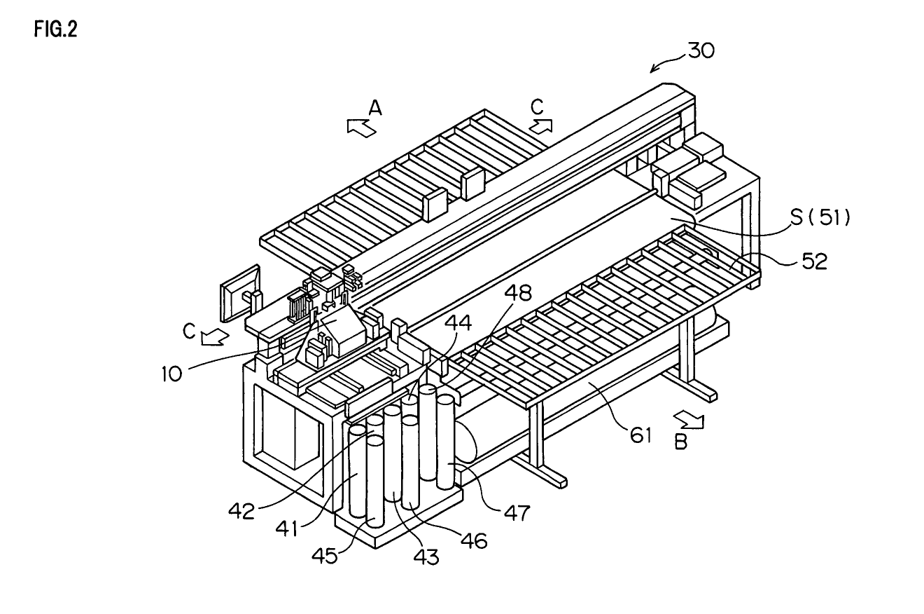

An embodiment of this invention will be described hereinafter with reference to the drawings. FIG. 1 is a schematic front view of an inkjet recording apparatus according to this invention, and FIG. 2 is a perspective view of the apparatus.

This inkjet recording apparatus records images on an elongate recording medium S by moving the recording medium S in a secondary scanning direction indicated by an arrow A or B in FIGS. 1 and 2, and moving a recording head 10 with a recording head moving mechanism 30 in a primary scanning direction, indicated by arrows C in FIG. 2, perpendicular to the secondary scanning direction.

Referring to FIG. 1, a porous endless belt 51 is wound around a pair of rollers 53 and 54. The endless belt 51 defines an upper running portion and a lower running portion. The surface of the upper running portion which contacts the recording medium S can hold the recording medium S by suction applied by a suction mechanism not shown. At least one of the rollers 53 and 54 is connected to a reversible motor, to be able to move the upper running portion of the endless belt 51 in both the direction of arrow A (first direction) and the direction of arrow B (second direction). The recording medium S is unwound from a first roller 61 rotatable by drive of a motor 65, to move through a tension adjusting mechanism 63 and onward as held by suction on the upper running portion of the porous endless belt 51. The recording medium S moves further through a tension adjusting mechanism 64 to be wound on a second roller 62 rotatable by drive of a motor 66. In this case, the recording medium S moves in the direction of arrow A (first direction) shown in FIGS. 1 and 2.

When the first roller 61 and second roller 62 are rotated in the direction reversed from the above, the recording medium S is unwound from the second roller 62, to move through the tension adjusting mechanism 64 and onward as held by suction on the upper running portion of the porous endless belt 51. The recording medium S moves further through the tension adjusting mechanism 63 to be wound on the first roller 61. In this case, the recording medium S moves in the direction of arrow B (second direction) shown in FIGS. 1 and 2.

These first roller 61, second roller 62 and endless belt 51 constitute a recording medium transport mechanism for transporting the recording medium S in both the first direction and second direction.

This inkjet recording apparatus can record also on a hard, plate-like recording medium instead of the elongate, soft recording medium S. In this case, an auxiliary table 52 shown in FIG. 2 is used in holding the hard, plate-like recording medium by suction on the endless belt 51. The auxiliary table 52 is adjusted to have an upper surface thereof located on the same plane as the upper running portion of the endless belt 51. Since at least one of the rollers 53 and 54 is connected to the reversible motor as noted above, the drive of this motor may be utilized to move the hard, plate-like recording medium in the secondary scanning direction as held by suction on the endless belt 51.

This inkjet recording apparatus carries out multi-color printing using yellow, magenta, cyan, black, light cyan, light magenta and white inks. As shown in FIG. 2, this inkjet recording apparatus includes a yellow ink tank 44, magenta ink tank 43, cyan ink tank 42, black ink tank 41, light cyan ink tank 46, light magenta ink tank 45 white ink tank 47, and cleaning solution tank 48.

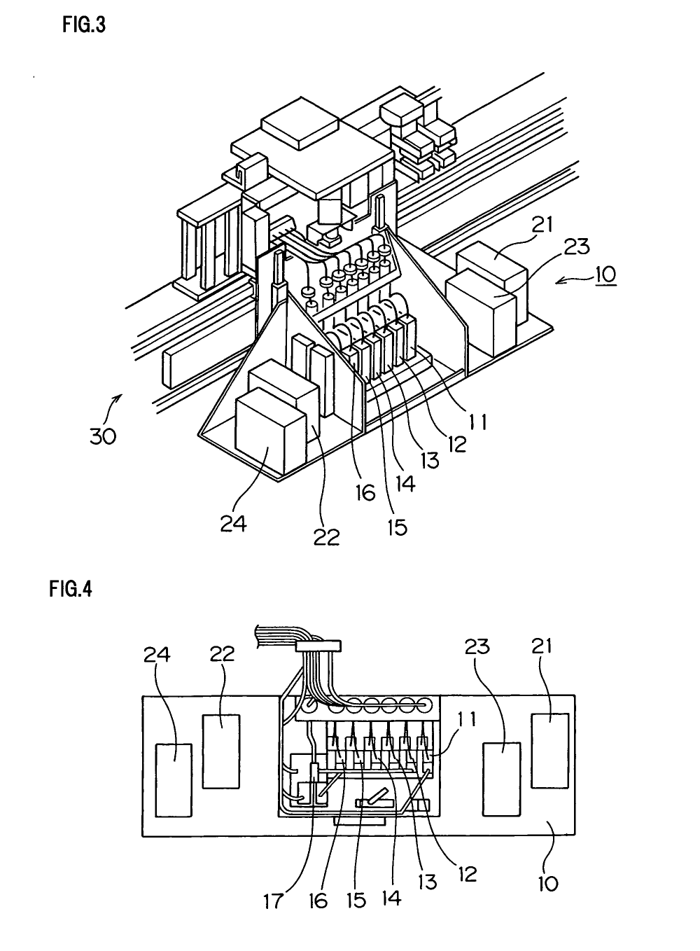

FIG. 3 is a perspective view of the recording head 10, and FIG. 4 is a plan view thereof. FIG. 5 is an explanatory view schematically showing an arrangement of inkjet heads 11, 12, 13, 14, 15, 16 and 17.

This recording head 10 includes an inkjet head 11 for light magenta ink, an inkjet head 12 for yellow ink, an inkjet head 13 for cyan ink, an inkjet head 14 for black ink, an inkjet head 15 for magenta ink, an inkjet head 16 for light cyan ink and an inkjet head 17 for white ink.

These inkjet head 11 for light magenta ink, inkjet head 12 for yellow ink, inkjet head 13 for cyan ink, inkjet head 14 for black ink, inkjet head 15 for magenta ink and inkjet head 16 for light cyan are arranged in the primary scanning direction (i.e. the direction of arrow C shown in FIG. 5). On the other hand, the inkjet head 17 for white ink is disposed in a position different from the inkjet heads 11, 12, 13, 14, 15 and 16 with respect to the secondary scanning direction (i.e. the direction of arrow A or B shown in FIG. 5), and either forward or rearward of the inkjet heads 11, 12, 13, 14, 15 and 16 with respect to the primary scanning direction. That is, the inkjet heads 11, 12, 13, 14, 15 and 16, and the inkjet head 17 for white ink, are staggered from each other in the secondary scanning direction.

As shown in FIGS. 3 and 4, a pair of UV lamps 21 and 22 are arranged at opposite sides of the group of inkjet heads 11, 12, 13, 14, 15 and 16 (i.e. in the same positions as the inkjet heads 11, 12, 13, 14, 15 and 16 with respect to the secondary scanning direction) for drying the color inks discharged from the inkjet heads 11, 12, 13, 14, 15 and 16. Another pair of UV lamps 23 and 24 are arranged at opposite sides of the inkjet head 17 for white ink (i.e. the same position as the inkjet head 17 for white ink with respect to the secondary scanning direction) for drying the white ink discharged from the inkjet head 17.

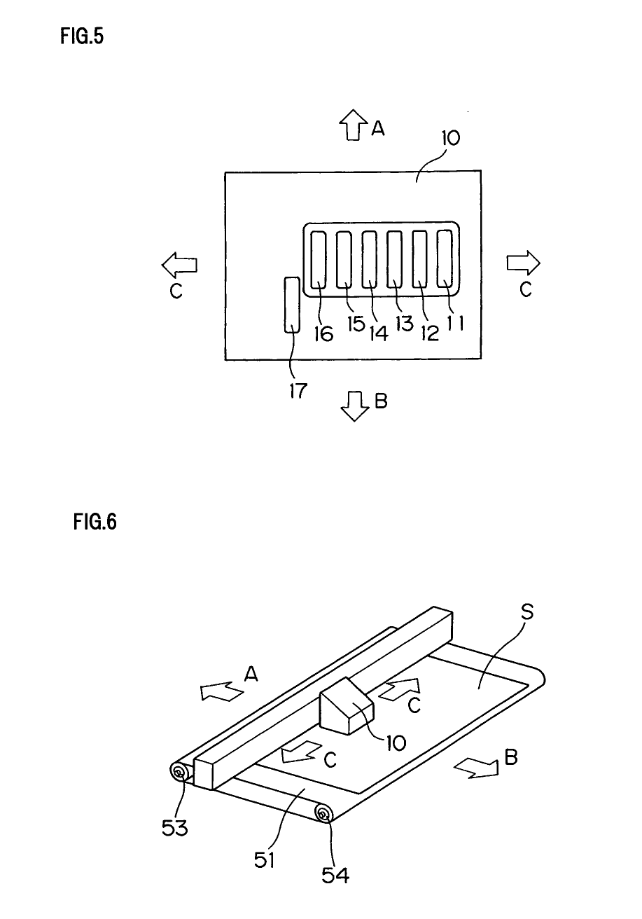

Next, operations of the inkjet recording apparatus having the above construction will be described. These operations are carried out for recording images through a pre-white process and a post-white process. FIG. 6 is an explanatory view illustrating the image recording operations. FIG. 6 depicts the elongate recording medium S as being in sheet form.

When this inkjet recording apparatus records an image in the pre-white process in which the image is printed in the white ink first and then in the color inks, the inks are discharged from the inkjet heads 11, 12, 13, 14, 15, 16 and 17 in response to image signals while moving the recording head 10 in the primary scanning direction. When the recording head 10 has moved to a stroke end in the primary scanning direction, the recording medium S is moved in the direction of arrow A shown in FIGS. 1, 2, 5 and 6 (i.e. in the first direction of the secondary scanning direction), by a distance corresponding to one scan of the recording head 10. For this purpose, the recording medium S is unwound from the first roller 61, moved as held by suction on the porous endless belt 51, and then wound on the second roller 62. In parallel with this action, the recording head 10 is moved in the direction opposite to the above image-recording direction, back to the opposite stroke end in the primary scanning direction.

By repeating such operation, the image is recorded on the recording medium S by the inkjet head 17 for white ink and by the plurality of inkjet heads 11, 12, 13, 14, 15 and 16 for color inks. At this time, the recording medium S is transported in the first direction in which the inkjet head 17 for white ink is located upstream, with respect to the secondary scanning direction, of the plurality of inkjet heads 11, 12, 13, 14, 15 and 16 for color inks. Thus, printing is done in the pre-white process in which the image is printed in the white ink first and then in the color inks.

When this inkjet recording apparatus records an image in the post-white process in which the image is printed in the color inks first and then in the white ink, again, the inks are discharged from the inkjet heads 11, 12, 13, 14, 15, 16 and 17 in response to image signals while moving the recording head 10 in the primary scanning direction. When the recording head 10 has moved to a stroke end in the primary scanning direction, the recording medium S is moved in the direction of arrow B shown in FIGS. 1, 2, 5 and 6 (i.e. in the second direction), by a distance corresponding to one scan of the recording head 10. For this purpose, the recording medium S is unwound from the second roller 62, moved as held by suction on the porous endless belt 51, and then wound on the first roller 61. In parallel with this action, the recording head 10 is moved in the direction opposite to the above image-recording direction, back to the opposite stroke end in the primary scanning direction.

By repeating such operation, the image is recorded on the recording medium S by the inkjet head 17 for white ink and by the plurality of inkjet heads 11, 12, 13, 14, 15 and 16 for color inks. At this time, the recording medium S is transported in the second direction in which the plurality of inkjet heads 11, 12, 13, 14, 15 and 16 for color inks become upstream, with respect to the secondary scanning direction, of the inkjet head 17 for white ink. Thus, printing is done in the post-white process in which the image is printed in the color inks first and then in the white ink.

In the foregoing embodiment, an image is recorded only when the recording head 10 moves in one direction from one end to the other end, and not when the recording head 10 moves in the opposite direction. Instead, the image may be recorded all through the reciprocating movement of the recording head 10. This invention is applicable also where the moving distance in the direction of arrow A or B of the recording medium S is set to what is the distance corresponding to one scan divided by an integer. Such a setting may be made in order to increase ink quantity or improve resolution.

The foregoing embodiment has been described to exemplify the case of printing in white ink the background of an image formed in color inks. However, this invention is applicable also where a color ink other than white (e.g. special color ink, black ink, etc.) is used as a background-color ink for printing the background of an image formed in color inks.

A recording medium may be coated all over with a liquid such as varnish for improving ink absorbency of the recording medium, or an agent for improving durability of the recording medium. This invention is applicable also where the recording medium is coated with such a liquid before or after image-recording inks are applied to the recording medium.

This invention may be embodied in other specific forms without departing from the spirit or essential attributes thereof and, accordingly, reference should be made to the appended claims, rather than to the foregoing specification, as indicating the scope of the invention.

This application claims priority benefit under 35 U.S.C. Section 119 of Japanese Patent Application No. 2007-148147 filed in the Japanese Patent Office on Jun. 4, 2007, the entire disclosure of which is incorporated herein by reference.

What is claimed is:

1. An inkjet recording apparatus for recording images on a recording medium by moving the recording medium in a secondary scanning direction with a recording medium transport mechanism, and moving a recording head in a primary scanning direction perpendicular to the secondary scanning direction, wherein:
said recording head includes a plurality of color inkjet heads arranged in an array in said primary scanning direction for discharging different color inks, and a background-color inkjet head for discharging background-color ink, said background-color inkjet head being disposed in a position different from said array of said color inkjet heads with respect to said secondary scanning direction, and adjacent one of a forward end and a rearward end of said array; and
said recording medium transport mechanism is constructed to transport said recording medium selectively in a first direction in which said background-color inkjet head is located upstream with respect to the secondary scanning direction, and in a second direction in which said color inkjet heads are located upstream with respect to the secondary scanning direction.

2. An inkjet recording apparatus as defined in claim 1, said background-color inkjet head is a white inkjet head for discharging white ink.

3. An inkjet recording apparatus as defined in claim 2, wherein said recording medium transport mechanism includes a porous endless belt wound around a pair of rollers to define an upper running portion and a lower running portion, a suction holding mechanism for holding said recording medium on said upper running portion of the endless belt, and a motor for selectively moving said upper running portion of the endless belt in said first direction and said second direction by rotating at least one of said rollers in opposite directions.
